(19) United States
(12) Patent Application Publication
(10) Pub. No.: US 2015/0352792 A1
(43) Pub. Date: Dec. 10, 2015

(54) 3D modeling and printing methods based on specification of height and width of each part

(71) Applicant: Yasusi Kanada, Tokyo (JP)

(72) Inventor: Yasusi Kanada, Tokyo (JP)

(21) Appl. No.: 14/726,650

(22) Filed: Jun. 1, 2015

(30) Foreign Application Priority Data
Jun. 6, 2014 (JP) P2014-118197

(51) Int. Cl. B29C 67/00; G05B 19/4099

(52) U.S. Cl. CPC B29C 67/0088; G05B 19/4099; B33Y 50/02

(57) ABSTRACT

The purpose of this invention is to enable forming 3D objects by a 3D printer with preserving 3D-printability by drawing free curves and lines by the nozzle, by keeping printed filament at the designed location, and by printing automatically without disturbed by obstacles.

To solve the problem above, the following means are to be used. First, printable shapes and patterns are given as parts,
a method for assembling the parts is given,
a method for deforming and transforming the parts and the assembled parts is given.
3D-printable shape creation is enabled by, in addition to methods for enlarging, reducing, and rotating them, a method for applying coordinate transformation function that is freely defined and generates free forms and patterns,
and combining the deformation and transformation while preserving 3D-printability.

### BACKGROUND OF THE INVENTION

A basic technology of 3D printers of so-called fused-deposition-modeling type, which use ABS resin or PLA resin filament, are described in the U.S. Pat. No. 5,136,515 by Richard Helinski. In addition, there are other types of 3D printers that uses materials which are gel state in room temperature but becomes solid by heat or light. By using such technologies, object models to be printed are sliced to thin layers, and each layer is formed by arraying filament in horizontal directions, and the layers are stacked.

The direction of filament can, thus, normally be observed in printed objects. In a sparsely-printed object, the shapes of filaments immediately after extrusion is preserved so the filament direction can be observed; however, in a densely-printed object, filaments are bonded to neighbor filaments and only limited traces of filaments can be observed. Because the print direction is horizontal, the direction of filament or the lines is restricted to be horizontal. When designing an object to be printed the shape of the model is designed by using a CAD tool and the designed shape is tried to be copied as exact as possible by a 3D printer.

### BRIEF SUMMARY OF THE INVENTION

### Problems to be Solved by this Invention

In a 3D printer of fused-deposition-modeling (FDM) type or another layering 3D printer, the print head can move not only to horizontal directions but also to vertical and oblique directions. So the nozzle at the tip of the print head can extrude filament while moving freely in the three-dimensional space. Therefore, by using a numerical-control (NC) program coded by G-Code and by using a tool that generates the program, the nozzle can draw free lines or curves such as circles, polygons, or splines, in the same way as in line arts. If the filament (as part of the printed object) can be kept (solidified) along the trajectory of the nozzle, the above curves and lines can be expressed in the object created by 3D printing. This means, objects with sense of directions and motions can be created. In addition, the area and shape of the filament cross-section can be varied.

There are two factors that prevent 3D-printability of 3D models. One is that it is difficult to keep an unsupported filament at a specific location in the air, and the other is that it is difficult to extrude filament at the designed location if there is an obstacle between the designed location and the location of the nozzle. These factors mean, because it is difficult to keep a filament that is extruded in the air at the original location, it is difficult to give free shape to the filament, and it is not possible to print it if an obstacle exists.

No general methods for programming nozzle motion and filament extrusion for automatic 3D printing with the following two conditions, i.e., keeping a filament to the designed location and guaranteeing no obstacle exists, are known. This invention is to give a method that can, while guaranteeing 3D-printability, create various shapes by moving the nozzle to every direction in the three-dimensional space.

### Means to Solve the Problems

To solve the above problem, various shapes and patterns should be prepared as predefined models (parts), and a method (tool) for assembling (combining) and deforming and/or transformation them should be given. By using a similar way to conventional 3D CAD, complex shapes can be formed by assembling predefined parts. However, there are shapes and patterns which are impossible or difficult to be created by this assembly-only method. A much more variety of shapes can be created by using deformations and transformations. Basic methods of deformations and transformations include enlargement, reduction, and rotation. More general deformations and transformations can be described by freely-defined coordinate transformations. By defining and applying coordinate transformations that preserve 3D-printability, various printable shapes can be created.

### The Effect of this Invention

By preparing printable shapes and patterns, and by using methods for defining deformations and transformations that preserve 3D-printability, 3D-printability of generated shapes and patterns can easily be guaranteed. Free deformations and transformations enable creation of shapes by freely moving the nozzle (the print head) in the three-dimensional space.

### BRIEF DESCRIPTION OF DRAWINGS

FIG. 1 shows the flow of 3D modeling and printing in the embodiment of this invention.

FIG. 2 explains the three types of models in the embodiment of this invention.

FIG. 3 explains the deformation-and-transformation processing 102 in the embodiment of this invention.

FIG. 4 explains the conditions that preserve 3D-printability and the method for preserving 3D-printability in the embodiment of this invention.

FIG. 5 explains the method for bonding filaments when the direction of the filament array is close to horizontal and the angle between the centers of the filaments are non-negative in the embodiment of this invention.

FIG. 6 explains the method for preserving 3D-printability when rotating the print head in the embodiment of this invention.

FIG. 7 explains the precision of print location (the precision of keeping printed filament at a specific position) in the embodiment of this invention.

FIG. 8 explains various shapes generated by application of deformation-and-transformation processing 102 with various conditions and parameters in the embodiment of this invention.

### DETAILED DESCRIPTION OF THE INVENTION (EMBODIMENT)

### [Modeling and Printing Procedure]

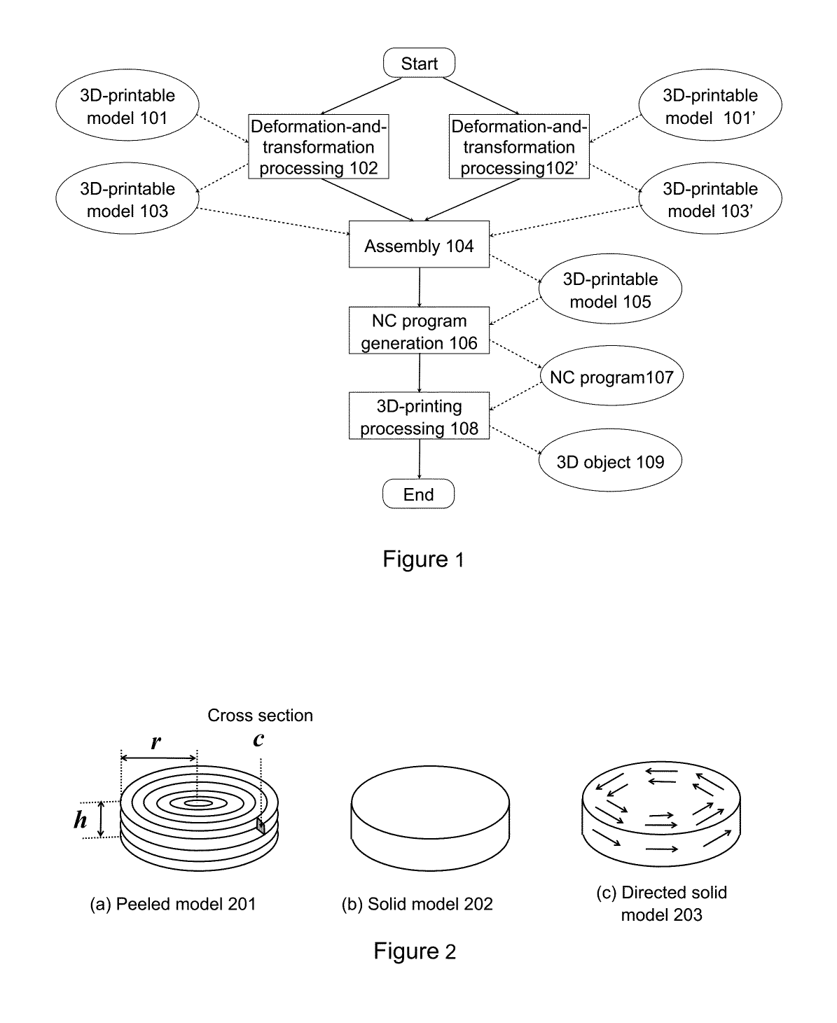

By using FIG. 1, the flow (procedure) of the 3D design and printing method that can create directed 3D objects by moving the nozzle (print head) of a 3D printer freely to every direction in the three-dimensional space is outlined. First, a 3D-printable model 101 is inputted to the printing system (to a computer that is a part of the printing system), and, if necessary, the model 101 is deformed and transformed by applying the deformation-and-transformation processing 102 and a 3D-printable model 103 is generated as the result. In this document, 3D-printability basically means that any 3D printer that only extrudes filament to the downward direction can print the specified model. However, this invention can also be applied to 3D-printing systems with print heads that can rotate along a horizontal axis. The conditions required for 3D-printability will be described later. In the same way as the above processing, by applying the deformation-and-transformation processing 102′ to a 3D-printable model 101′, a 3D-printable model 103′ is generated. A combination of two models is used in this embodiment; however, combinations of three or more models can also be used. The deformation-and-transformation processing 102 and 102′ must preserve 3D-printability.

As described above, one or more 3D-printable models can be generated. By applying the assembly processing 104 to generated 3D-printable models 103, 103′, and so on, a 3D-printable model 105 is generated. The assembly processing 104 can preserve 3D-printability. The deformation-and-transformation processing 102 can be applied again to the 3D-printable model 105, which is generated by the assembly processing 104. That means, the above processing can be repeated any number of times.

If the 3D-printable model 105 is a peeled model (which is defined later), that is, if the 3D-printable model 105 is decomposed into string-shaped parts, an NC program 107 in G-Code can be generated by executing the NC-program-generation processing 106. The NC program 107 traverses the strings specified in the 3D-printable model 105 and extrudes filament, where the amount of each part of filament depends on the thickness (the cross section) of the corresponding part of string. By outputting this program 107 to a 3D printer, the above-described model can be printed. According to the program 107 which is outputted to the 3D printer, the control system of the 3D printer controls the print-head motion-direction and motion-velocity and the extruder controls the print velocity, i.e., the filament extrusion velocity, and the 3D printer effectively controls the printing velocity, i.e., the filament-extrusion velocity. In this context, the filament extrusion velocity is expressed by either extruded filament volume per second or extruded filament length per second, i.e., the line speed.

### [Conditions to be 3D-Printable]

The conditions of 3D printability (i.e., the set of conditions that makes 3D printing possible) are the following two. The first condition is that previously printed strings (filaments in design) do not prevent the printing process. If there is a string between the nozzle of the print head and the print location (the position to be placed melted filament), the printing fails. The second condition is that the newly printed string keeps (is solidified) at the designed location by a supporter. The supporter may be either a print bed, previously printed string, or support material (which is material used only for supporting strings and to be removed after printing). The string is not necessarily supported from underneath, but it can be supported (from oblique or horizontal direction) if it is pressed to a supporter in a horizontal (or oblique) direction. If printed string is placed at a location where the string does not contact with any supporter, the string goes out of the placed location and moves to a downward or horizontally out-of-place location. To be 3D-printable, both of these conditions must be satisfied.

[Three Types of Models and Application of the Procedure to them]

The procedure shown in FIG. 1 can be applied to the three types of models shown in FIG. 2. In the first type of application, a peeled model 201, which was created by peeling (decomposing) the original model into strings that correspond to filaments (in other words, by hashing or slicing the model into strings), is used; that is, the 3D-printable model 101 and 101′ have been peeled. The model specifies the trajectory of the print head (i.e., the tool-path) and specifies the cross section or the height, width of the filament, and the direction for each part of string. The model described above is used for a 3D-printable model 101 and 101′, and the method shown in FIG. 1 is applied. The cross section, the height, and the width of each portion of a string may be different from other portions. It is preferable that the peeled model 201 consists of connected strings, i.e., is traversable; however, it may consists of multiple unconnected portions. If they are not connected, they are traversed when printing (when generating G-Code). In this first type of application, a 3D-printable model 105, which is generated by the assembly processing 104, is also peeled. In addition, a print velocity, i.e., the velocity of the print head that extrudes filaments, can also be specified for each portion of a peeled model, such as (x, c, v) where the coordinate is x, the cross section is c, and the velocity is v. An extrusion velocity can be specified instead of print velocity (i.e., head-motion velocity). However, if both print velocity and extrusion velocity are specified, they may be inconsistent with the specified cross section.

In the second type of application of the method shown in FIG. 1, as shown in FIG. 2(b), the solid model 202 is used. The solid model 202 is similar to normal 3D CAD, where the model is not initially peeled. In the third type of application, the solid model 203 is used. In the solid model 203, the print direction is specified as shown in FIG. 2(c). This means, the method shown in FIG. 1 is applied to one of these models as 3D-printable model 101 and 101′. However, also in the second type of application, the solid model 202 should be confirmed to be 3D-printable beforehand. The 3D-printable model 105, which is generated by the assembly processing 104, is also a normal solid model or direction-specified solid model. If the deformation-and-transformation processing 102 preserves 3D-printability, the model 105 generated by the deformation-and-transformation processing 102 is also 3D-printable. In addition, in the second and third types of application, because parameters such as the cross section or the distance from the neighboring string (filament) are not predefined in the predefined parts library, such parameters are not necessarily required to be taken into account in the assembly processing 104 and the processing executed before the assembly processing 104.

FIG. 2 shows three cylinder models which are assumed to be predefined in the parts library. In addition to these models, peeled models, undirected solid models, and directed solid models can also be predefined in the library for other shapes, i.e., cuboid, triangular prism, and sphere. The procedure shown in FIG. 1 can be executed regardless of which one of these models are selected and regardless of how they are combined. If 3D-printability is preserved, a 3D-printable peeled model 105 can be obtained by this procedure.

If the 3D-printable model 105 is a solid model, the NC-program-generation processing 106 is a combination of peeling (or, hashing or slicing) the model 105 and transforming it to an NC program such as G-Code, and the NC program 107 is generated as the output. In either case, the NC program 107 is outputted to normal 3D printer and the 3D printing processing 108 is executed, then the 3D object 109, which contains filaments directed to various directions in the three-dimensional space.

### [Structure of Peeled Model]

As described above, regardless of which model in the three types of models is used, a peeled model can be generated and can be printed. The structure of the peeled model is thus described below. If the peeled model 201 is represented by a sequence of bounded lines (but has non-zero thickness), each line (string) can be represented by a pair of coordinates of the starting and ending points of the line. For example, the following expression represents a peeled model.

((−1,−1,0)−(1,−1,0),(−1,1,0)−(1,1,0)) (1)

This peeled model consists of two lines: one of them is from (−1, −1, 0) to (1, −1, 0) (which are Cartesian coordinates) and the other is from (−1, 1, 0) to (1, 1, 0). Although these lines are represented by a pair of coordinates, the start point of the latter line can be omitted if it is the same as the end point of the former line. For example, the following expression can represent a peeled model consists of a line from (−1, −1, 0) to (1, −1, 0) and a line from (1, −1, 0) to (1, 1, 0).

((−1,−1,0)−(1,−1,0)−(1,1,0)) (2)

A peeled model can also be represented by polar coordinate system or another type of coordinate system instead of Cartesian coordinate system. In particular, it can be represented by a coordinate system in which the nozzle motion direction is always the front direction (i.e., egocentric polar coordinate system; in other words, the coordinate system used for flight simulator). This coordinate system is convenient for drawing and printing 3D turtle graphics (i.e., drawing a trajectory of print head, which is regarded as a turtle, by filament). For example, 3D-printing a circle by the following sequence of commands, such as follow, is often graphically (not physically but virtually) executed by using programming language such as Logo.

repeat 72

forward 5
left 5

This program repeats an action sequence, i.e., moving forward 5 mm and turning left 5 degrees, 72 times.

Extruding filament from the nozzle while moving as described above, the filament forms a circule. Moving up or down motion can also be specified in 3D turtle graphics. (For example, “up 5” (head up 5 degrees).) However, if moving up in the air, the printed filament is dropped, so, (when calculating the trajectory) by determine the gravity direction, the head must be moved just over the previously printed filament. In conventional turtle graphics, a virtual turtle draws a curve in 2D or 3D virtual space, and the result can be displayed on a computer display. In addition, a physical turtle can hold a pen and can move so that it can draw 2D curve in the real space. In the same way, a 3D curve can be drawn in the physical 3D space by using the above method.

A 3D printer that directly executes the above program can be developed; however, most of existing 3D printers are designed to execute NC programs such as G-Code, so the above program must be transformed to an NC program by using a computer. One of the following two methods can be used for this conversion. The first method is to input the above program as data. In this method, a program in the computer transforms the input program as data to an NC program. The second method is to input the above program as program. In this method, a library (application programming interfaces or APIs) for processing the above program or for a program in a conventional language, which expresses the same meaning as the original program, is prepared, the program is executed by using a conventional language processor, and the program outputs an NC program. The above conversion methods can be applied not only to programs for turtle graphics but also to programs using Cartesian, cylinder, or polar coordinate system.

Cylinder coordinate with egocentric direction or polar coordinate with pseudo-egocentric direction (horizontally egocentric but with zero elevation angle) can be used for a coordinate system for 3D turtle graphics. These coordinate systems can be called the egocentric cylinder coordinate system and the pseudo-egocentric polar coordinate system. If cylinder coordinate is used, the motion of print head can be represented by a triple: horizontal motion amount, rotation angle of the print head in the horizontal 2D space, and previously described vertical motion amount of the head.

In this case, if the filament diameter is 0.5 mm or close, the vertical filament pitch (interval) can be set to 0.4 mm and a cylinder can be printed by using the following command sequence.

repeat 50 * 72

forwardAndUp 5, 0.4 / 72
left 5

This program repeats a sequence of action, i.e., moving up 0.4/72 mm, moving forward 5 mm, and turning left by 5 degree, 50*72 times. The reason why moving-up and moving-forward actions are performed at once is that, if they are divided, filaments are not smoothly layered. By moving up and forward at once, the shape of extruded and stacked filament is approximately a helix.

In addition, when using a polar coordinate, a triple (r, theta, phi), where r means the motion amount according to the motion direction in the 3D space, theta means the depression angle (azimuth), and phi means the elevation angle that is orthogonal to the depression angle, can represent the print-head motion described above. In the case of polar coordinate, an egocentric coordinate, in which the turtle always faces the front direction similar to a flight simulator, is used. However, if a polar coordinate is used, because it becomes difficult to decide the gravity direction, it becomes difficult to design filament stacking (layering) exactly. So cylinder coordinate system may be better.

Note that the above sequence of coordinates such as (1) or (2), can be connected by a curve such as a spline, instead of linear lines. This means, a “straight peeled model” such as (1) or (2) can be reinterpreted as a “curved peeled model” connected by a spline. If they are interpreted as above, the print head should be controlled to move and to print along the spline.

### [Necessary Condition for Designing a Peeled Model]

The thickness of a string (i.e., a line or connected lines) in a peeled model 201 varies by deformation-and-transformation processing 102. To preserve 3D-printability of the peeled model 201 by the transformation, the following design condition must be satisfied when the model is inputted to the NC-program-generation processing 106. (Therefore, to satisfy this condition when selecting the peeled model 201 first time, the pitch of the string and the cross section must be designed to have sufficient margins.) The following conditions are instances of the previously described 3D-printability conditions for the peeled model.)

The first condition to be satisfied is that the cross section of the (logical) string which is contained in the peeled model 201 is slightly larger than the cross section of the physical filament that is extruded by the 3D printer. (Assert that the inner radius of the nozzle of the printer is r, then the cross section of the filament when extruded is pi*r*r (where pi is the circular constant).) This condition is the condition for the filament not to be excessive when printing. However, even if the (logical) cross section of the designed string is slightly over the (physical) cross section of the filament, this condition may be loosen because the filament may shrink to fit in the space according to the printing condition. In addition, this condition may intentionally be dropped as described below.

The second condition to be satisfied is that a string and another string beneath the first string or the horizontally neighboring string is to be contacted. If the height of the string or its cross section is small and the filament that corresponds to the string is smaller than the space that is to be filled with the filament (see FIG. 7(a)), the filament sinks to the space, such as shown in FIG. 7(b), and the precision to be satisfied is not satisfied.

### [Method of Controlling Cross Section or Height/Width]

A method for controlling the height and width or controlling the cross section is explained below. There are two methods for controlling them. The first method is to control the motion velocity of the print head. If the extrusion velocity of filament is constant, the cross section becomes m times larger when the motion velocity of the print head becomes m times larger. In addition, if the height is constant then the width becomes m times larger, and if the width is constant then the height becomes m times larger. The second method is for controlling the extrusion velocity of filament. If the motion velocity of the print head is constant then the cross section is m-times larger. By combining these methods, the cross section can be controlled by varying both the motion velocity of the print head and the extrusion velocity of filament.

### [Basic Method for Deformation-and-Transformation Processing]

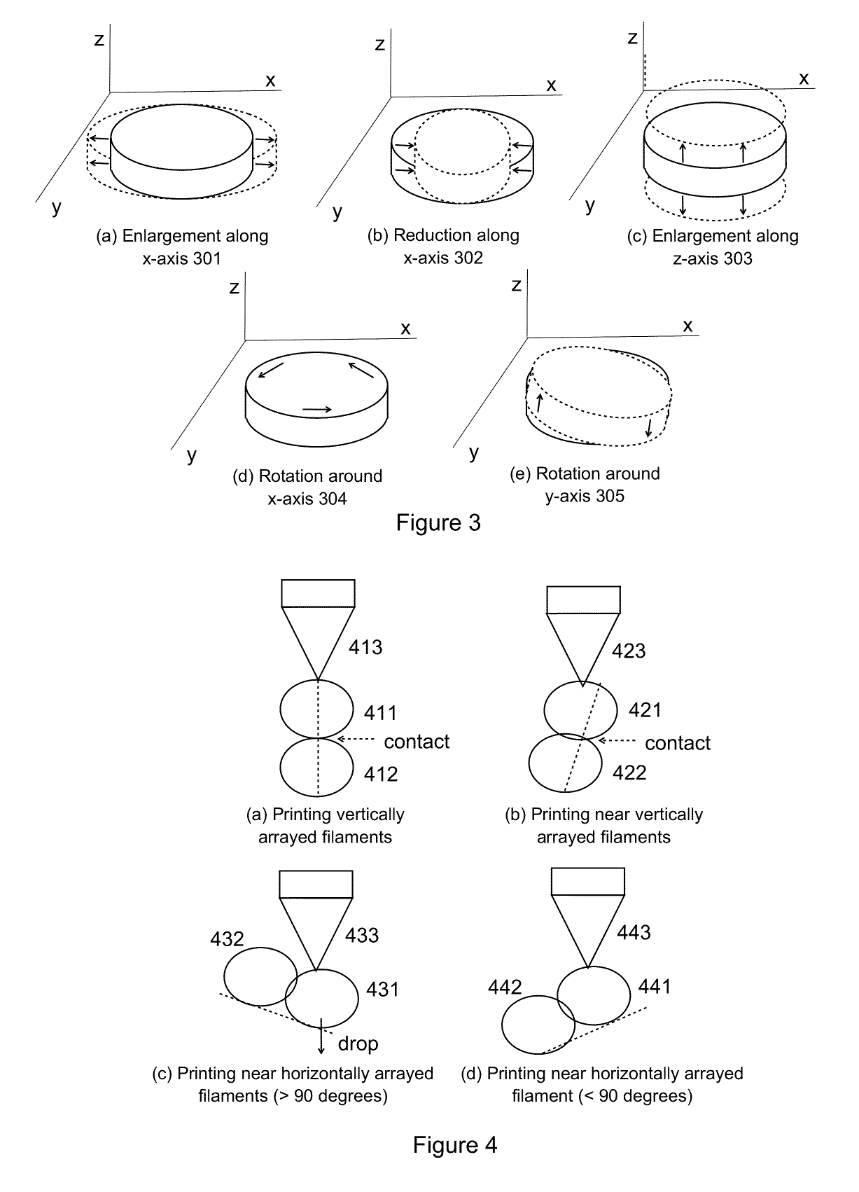

By using FIG. 3, the deformation-and-transformation processing 102 is explained below. First, the horizontally uniform (i.e., along x or y axis) enlargement 301 or reduction 302, which is one of the basic types of deformation-and-transformation processing 102, is explained. When applying a horizontal enlargement or reduction to the peeled model, if the ratio of enlargement is m (m>1 when enlargement and m<1 when reduction), it is required to enlarge or to reduce the cross section of the string, c, to m*c. If the printing velocity (i.e., the motion velocity of the nozzle) is unchanged, the extrusion velocity of the filament must be m*m times larger. In the case of enlargement or reduction only for x-axis direction, the cross section of the string must be the same (i.e., 1 times larger) for x-axis direction and it must be m times larger for y- or z-axis direction, and if the print direction is constant, the extrusion velocity of the filament must be m times larger without depending on the direction of enlargement or reduction. To enlarge/reduce the cross section by m times with constant printing velocity, the printing velocity specified for the peeled model after the transformation should be the same as the original printing velocity. In contrast, to increase/decrease the cross section by m times, the printing velocity specified for the peeled model after the transformation should be 1/m times. However, the printing velocity may not be too fast. That means, the precision will be lower if a filament is printed before the temperature of the neighboring filament has not yet become sufficiently lower, so the printing velocity should sometimes be suppressed.

In the same way, in the case of enlargement or reduction along the y-axis only, the cross section of the string must be kept to be the same when the string is y-axis direction, it must be m times larger when the string is x- or z-axis direction, and when the print velocity is constant, it must be m times larger. If the string is skewed, the extrusion velocity is also m times larger. In any case above, 3D-printability is preserved if the head can extrude m times larger amount of filament. The cross section may vary when changing the motion velocity of the nozzle. If the extrusion velocity is unchanged, the motion velocity is 1/m times larger when the cross section becomes m times larger.

Second, a constant (uniform) enlargement 303 or reduction toward the vertical direction (i.e., z-axis direction), which is another instance of deformation-and-transformation processing 102, is explained. By applying a vertical enlargement or reduction to a peeled model, if the ratio or enlargement is m (m>1 in the case of enlargement and m<1 in the case of reduction), the cross section does not vary when the direction of the string is z-axis direction. However, in this case, if the print velocity, i.e., the motion velocity of the nozzle, is unchanged, the extrusion velocity of the filament must be m times larger. If the direction of the string is horizontal, it is necessary to enlarge or to reduce the cross section of the string, c, to m*c, and the extrusion velocity of the filament must be m times larger. If the direction of the string is oblique, 3D-printability can be preserved by increasing or decreasing the filament extrusion by m times. Also in this case, the motion velocity of the nozzle can be varied instead of varying the extrusion velocity.

Third, rotation is the third basic deformation-and-transformation processing 102, so rotation is explained below. If the axis of rotation 304 is parallel to the z-axis, 3D-printability is not affected. If the rotation axis 305 is not parallel to the z-axis, 3D-printability is not preserved when the rotation angle is large (but 3D-printability is preserved when the rotation angle is small).

### [Condition of Preserving 3D-Printability and Method of Preservation]

If the rotation axis is parallel to the z-axis, 3D-printability is naturally preserved; however, a certain method must be applied to preserve 3D-printability. When the rotation axis 305 is not parallel to z-axis, the condition of 3D-printability preservation and the method for preserving 3D-printability is explained by using FIG. 4. In the cross section 401 of the filament, which is printed based on the model before the transformation, an upper filament 411 is pressed to the lower filament 412, so they are bonded. The shape of the cross section of the filament just after extrusion is close to a circle; however, the shapes of the cross sections of filament 411 and 412 become close to ellipses because they are pressed to be bonded. The bottom tip of the triangle 413 shows the location of the nozzle.

Even if the model is printed after rotating it by a small rotation angle (FIG. 4(b)), the upper-lower relationship of filaments 421 and 422 are preserved (that means the upper filament still stays upper), so they are bonded, and the 3D printer works in the same way without a problem when printing the model. However, if the model is rotated by 90 degrees or more (FIG. 4(c)), the upper-lower relationships of filament 431 and 432 are reversed, and they becomes unbounded, it will be difficult to print it unless the printing order is not reversed.

If the model is printed after rotating by an angle less than 90 degrees (FIG. 4(b)), problems may occur; that is, the filament may be excessive and wavy, or the upper filament does not contact to the lower filament and is dropped. In addition, neighboring filaments may contact each other but do not bond each other because they do not pressed together.

To solve the above problem, one of the following two methods should be applied. First, if the angle is less than 90 degrees, the following first method can solve it and the model remains 3D-printable. As described above, the cross section must be enlarged or reduced for the upper string to be contacted to the lower string. However, if the extrusion velocity of filament (string) is increased to increase the cross section, the filaments (strings) may become wavy or bended and they will not contact each other, one of the following two methods should be applied. The first method is that, instead of increasing the extrusion velocity, the motion velocity of the nozzle (print head) must be reduced instead of increasing the extrusion velocity.

However, although this method can reduce the waving of filament, it is difficult to resolve this problem completely. To solve this problem, the second method is to select a nozzle (print head) with larger inner diameter. This method can resolve the problem of waving.

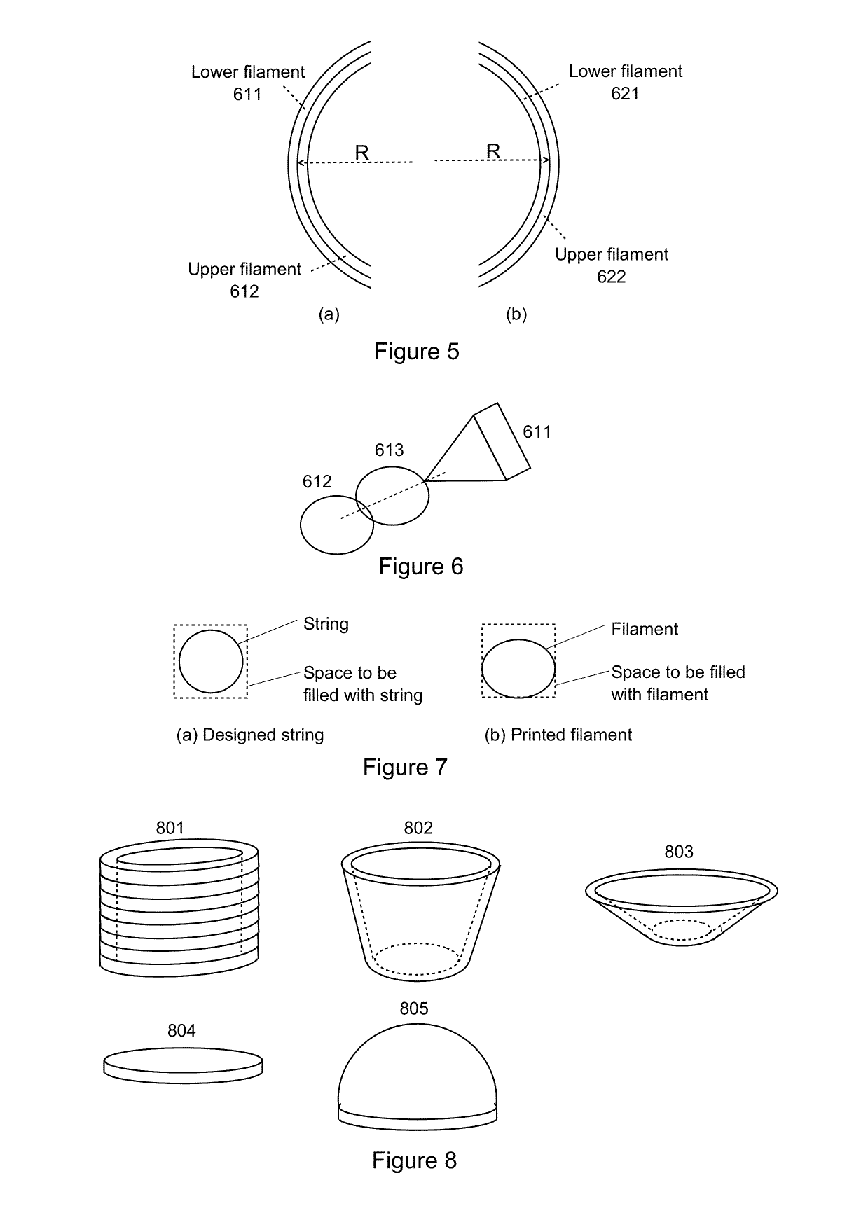

Second, when rotating the model by little less than 90 degrees, the neighboring filaments are mostly horizontally arrayed, so it becomes difficult to press to and to bond with the filaments. In this case, the filaments can be bonded by using the method shown in FIG. 5. Firstly, as shown in FIG. 5(a), when the lower filament (string) 511 is at left and the upper filament (string) 512 is at right and when the filament is convex to the left, that is, the center of the curvature radius is at right, the filament is extruded more (to be slightly excessive), that is, the motion velocity of the nozzle is set to be relatively smaller compared with the extrusion velocity of the filament (i.e., less than the normal value). Then the filament is pressed to the left and it is bonded to the left filament. Secondly, as shown in FIG. 5(b), when the filament is convex to the right, that is, the enter of the curvature radius is at left and when the lower filament 521 is at left and the upper filament 522 is at right, the deficiency and excess of the filament should be adjusted at each location.

As described above, it is difficult to preserve 3D-printability when the rotation angle is more than 90 degrees (but not impossible). On the contrary, when the angle is less, the object becomes 3D-printable if the order of printing is reversed, that is, the direction of the strings and the printing order are reversed. When the angle is approximately 90 degrees, the object may become 3D-printable by applying the method shown in FIG. 5 because the filament is bonded together.

The method for preserving 3D-printability described above is a method that can be applied to situations that filament is extruded only to downward; however, if the print head can rotate, a method described below can also applied. That is, as shown in FIG. 6, by extruding filament to the direction of line between the centers of lower filament 612 and the upper filament 613 by rotating the print head 611, the print head 611 pushes filament 613 to filament 612, and the filaments can be easily bonded.

### [Method of Free-Form Deformation-and-Transformation]

Three types of the deformation-and-transformation processing 102 described above are the most basic ones; however, instead, a coordinate transformation function can be used for a more flexible transformation. That is, a function that can map each coordinate of a point in the model 101 to a coordinate of a point in the model 103, which the deformation-and-transformation processing 102 outputs, can be given. Cartesian coordinate system, (x, y, z), can be used for representing each coordinate of the points in the model 101 and 103. Cylinder coordinate system, (r, theta, z), or polar coordinate system, (r, theta phi), can also be used. If a continuous function is used for the coordinate transformation function, the cross sections after the transformation can be relatively easily computed (approximated) and whether 3D-printability is preserved or not can also relatively easily be confirmed.

If the deformation-and-transformation processing 102 is based on the cylinder coordinate system, the deformation-and-transformation processing 102 can be described by a deformation function deform_cylinder(fp, fv, fc, m), where fp(r, theta, z) is a coordinate transformation function, fv(v, r, theta, z) is a function that maps the original print head motion velocity v and coordinate (r, theta, z) to the print head motion velocity (after the transformation), and m represents the model 101. The value that is returned by this deformation function is the model 103.

An example of deformation is explained below using FIG. 8. If helix (or a set of layered circles) 801 is given as m, and the following coordinate transformation function fp are given, the function returns a shape similar to a tapered cup 802 or a shape similar to a plate (but without a bottom) 803.

fp(r,theta,z)=(r+a*z,theta,z)(z<=0,a>0)

Function fp returns triple values (r′, theta′, and z′), where r′ is the value of r after the transformation, theta′ is the value of theta after the transformation, and z′ is the value of z after the transformation. The velocities of the print head and filament does not concern the shape. The transformation can also be described by a coordinate system other than the cylinder coordinate.

In addition, by combining the cup without a bottom or plate with a bottom by applying the combination processing 104, a shape of the above described cup with a bottom can be generated.

Instead of using a transformation that is uniform along the z-axis, a more general shape such as a vase with a narrow neck can be formed by using deformation functions such as third order curves or triangular functions.

Moreover, by using a deformation function deform_cylinder and by updating the print head motion velocity (or filament velocity) but not changing the shape, the cross section of filament and the shape can be changed. In addition, when the shape is transformed by a coordinate transformation, in addition to fp, by giving a function fv or fc (which is not the identity function), 3D-printability can be preserved. By using a non-linear coordinate transformation for fp, a shape different from the original shape can be generated. For example, a plate or vase, which have non-uniform cross section, can be created.

The shape used for generating a widely-opened cup or a plate is a cup with open top; however, if the same cup is mapped to a closed shape by mapping the top of the cylinder to a point at r=0. For example, if the upper part of a cylinder is looped along meridians of a sphere while horizontally shrunk the cylinder by deformation, a half sphere with a bottom, 805, can be formed.

It is possible to compute the print head motion velocity automatically by computing the magnification ratio of the cross section by the coordinate transformation. However, a better print result can be obtained by using and adjusting a non-identical function fc.

What are claimed are:

1. A method for 3D modeling and printing, which inputs a 3D object model and represents said 3D object model by a set of components that correspond to filaments which are to be extruded from the print head and to form a 3D object by a 3D printer; comprising
(a) first process that specifies the height and the width or cross section to each of said components, and
(b) second process that inputs said 3D object model and forms said 3D object by controlling the amount of said filaments to approximate said height or said width or said cross section.

2. A method for 3D modeling and printing according to claim 1; wherein
said second process controls the motion speed of said print head to approximate said height and said width or cross section.

3. A method for 3D modeling and printing according to claim 1; wherein
said second process controls the filament extrusion speed to approximate said height and said width or cross section.

4. A method for 3D modeling and printing according to claim 1; wherein
each of said components is expressed as a peeled model that consists of a connected string or of ordered multiple strings.

5. A method of 3D modeling method according to claim 4; wherein
each part of said peeled model is specified by a pair of coordinates of the both ends of the string, and
each part of said peeled model is approximated by a line and are printed.

6. A method of 3D modeling method according to claim 4; wherein
each part of said peeled model is specified by a sequence of coordinates, and
each part of said peeled model is approximated by a spline curve and are printed.

7. A method of 3D modeling method according to claim 4; wherein
each part of said peeled model specifies the printing velocity.

8. A method of 3D modeling method according to claim 4; wherein
each part of said peeled model specifies the filament extrusion velocity.

9. A method of 3D modeling method according to claim 1; wherein
said (first) object model is printable by said 3D printer; comprising
(c) a deformation-and-transformation processing that converts said first object model to second 3D object model which is also printable by said 3D printer, and
(b1) said second process inputs said second 3D object model and forms said 3D object.

10. A method of 3D modeling method according to claim 9; wherein
said deformation-and-transformation processing includes coordinate transformation of the coordinates of said components.

11. A method of 3D modeling method according to claim 9; wherein
said deformation-and-transformation processing includes transformation of height and width or transformation of cross section.

12. A method of 3D modeling method according to claim 9;
when forming and printing said second 3D object model,
the specified height and width or the cross section of a said component is approximated, and the approximated lines are printed.

13. A method of 3D modeling method according to claim 12; wherein
said height and width or said cross section is approximated by controlling the printing velocity at a said component.

14. A method of 3D modeling method according to claim 12; wherein
said height and width or said cross section is approximated by controlling the filament extrusion velocity at a said component.

15. A method of 3D modeling method according to claim 10; wherein
a non-linear transformation is used as said coordinate transformation, and
said second 3D object model with a shape, different from said first 3D object model.

16. A method for 3D printing, which extrudes filament from the print head of a 3D printer and forms a 3D object;
comprising a program-processing process wherein
said program-processing process inputs a program that specifies a sequence of pairs of: (1) the head motion amount and (2) the rotation angle according to a coordinate system in which the motion direction of said print head is defined as the front direction, and
said program-processing process forms said 3D object by translating and by executing said program by said 3D printer.

17. A method of 3D modeling method according to claim 16; wherein
a egocentric cylinder coordinate system is used as said coordinate system,
said 3D printer prints said 3D object by executing first program that represents said print head motion by a sequence of pairs of: (1) the horizontal motion and rotation angle and (2) a motion quantity of vertical direction of said print head,
or said 3D printer prints said 3D object by executing second NC program that is outputted by a computer that inputs said first program as data or as an executable program that is called from said first program.

18. A method of 3D modeling method according to claim 16; wherein
a egocentric or pseudo-egocentric polar coordinate system is used as said coordinate system; and
wherein said 3D printer prints said 3D object by executing first program that represents said print head motion by a sequence of triples of the motion amount according to the motion direction in the 3D space, and a horizontal depression angle, and a vertical azimuth angle of said print head, or
wherein said 3D printer prints said 3D object by executing second NC program that is outputted by a computer that inputs said first program as data or as an executable program that is called from said first program.
